(19) United States
(12) Patent Application Publication
(10) Pub. No.: US 2023/0360003 A1
(43) Pub. Date: Nov. 9, 2023

(54) AUTOMATED VEHICLE SERVICE SYSTEMS, DEVICES AND METHODS

(71) Applicant: Automotive Intelligence Technologies Inc., Laval (CA)

(72) Inventors: Marco Lisi, Laval (CA); Richard Titcombe, Toronto (CA)

(21) Appl. No.: 18/131,714

(22) Filed: Apr. 6, 2023

Related U.S. Application Data
(60) Provisional application No. 63/327,863, filed on Apr. 6, 2022.

(51) Int. Cl. G06Q 10/20; G06Q 10/1093; G06Q 30/0251; G07C 5/00

(52) U.S. Cl. CPC G06Q 10/20; G06Q 10/1095; G06Q 30/0251; G07C 5/008

(57) ABSTRACT

System and methods of notifying a customer of a maintenance service to be performed on a vehicle are described herein. The systems include a communication component to communicate with the vehicle via a network and at least one processor in communication with the communication component. The processor is operable to: receive vehicle maintenance service data from the vehicle, the vehicle maintenance service data including vehicle identification data and an indication of a maintenance service due to be performed on the vehicle; based on the vehicle identification data, retrieve customer data of the customer associated the vehicle, the customer data including customer identification data; based on the customer identification data, generate a message notifying the customer of the maintenance service due to be performed on the vehicle and providing a hyperlink for the customer to use to schedule a service appointment for the vehicle; and transmit the message to a customer device of the customer notifying the customer of the maintenance service to be performed on the vehicle.

### CROSS-REFERENCE

The present application claims the benefit of U.S. Provisional Patent Application No. 63/327,863 entitled AUTOMATED VEHICLE SERVICE SYSTEMS, DEVICES AND METHODS filed on Apr. 6, 2022, the entire contents of which are hereby incorporated by reference herein.

### FIELD

This disclosure relates generally to service systems, device and methods, and more specifically to automated vehicle service systems, devices and methods.

### BACKGROUND

In today's electronically networked world, the ability to obtain information in real-time, and more specifically the ability to obtain vehicle information in real-time from a vehicle, is rapidly improving.

In terms of vehicles, most new vehicles have service sensors that identify service requirements and provide an indication when a service is due. This indication may be displayed to an operator of the vehicle. In some cases, the car may also automatically transmit service-related data to a service provider. This provides the service provider, which is commonly a vehicle dealership, with instantaneous access to vehicle service data.

For example, BMW® Teleservice is a service that provides for a preferred dealership or service provider to receive detailed information from BMW®, which in turn receives the detailed vehicle service information directly from the vehicle, without the need of a service visit. This vehicle service information may include, for example, a condition of the vehicle such as but not limited to when the vehicle is in need of an oil change, a vehicle inspection and/or new brake pads. Services like BMW® Teleservice provide for personalized vehicle service as well as quick responses in the event of an issue that requires service of the vehicle.

In addition to these vehicle-based technologies, the service providers also typically have their own unique, customer specific data stored in a data management system (DMS). This data may include the customer's contact information, purchase history and/or service history for other vehicles. Service provides use this data together with technologies currently available to text or call a vehicle owner to arrange a service appointment or to provide updates during a service appointment, if necessary.

Unfortunately, current technologies do not provide for vehicle service information received by service providers to be integrated with their existing DMSs that store customer specific information.

Accordingly, there is a need for new DMSs that integrate vehicle service information received by service providers with existing DMSs storing customer specific information to offer service providers with an integrated service management system.

### SUMMARY

In accordance with a broad aspect, a system for notifying a customer of a maintenance service to be performed on a vehicle is described herein. The system includes a communication component to communicate with the vehicle via a network and at least one processor in communication with the communication component. The at least one processor is operable to: receive vehicle maintenance service data from the vehicle, the vehicle maintenance service data including vehicle identification data and an indication of a maintenance service due to be performed on the vehicle; based on the vehicle identification data, retrieve customer data of the customer associated the vehicle, the customer data including customer identification data; based on the customer identification data, generate a message notifying the customer of the maintenance service due to be performed on the vehicle and providing a hyperlink for the customer to use to schedule a service appointment for the vehicle; and transmit the message to a customer device of the customer notifying the customer of the maintenance service to be performed on the vehicle.

In at least one embodiment, the vehicle maintenance service data is received by the communication component from a teleservice module of the vehicle.

In at least one embodiment, the customer data is stored in a vehicle dealer-level software program.

In at least one embodiment, the processor is further operable to, after the customer schedules the service appointment, generate a second message reminding the customer of the service appointment.

In at least one embodiment, after generating the second message reminding the customer of the service appointment, receiving a confirmation message from the customer device, the confirmation message including an acknowledgement from the customer device of the service appointment.

In at least one embodiment, the processor is further operable to, after receiving the confirmation message, retrieve additional vehicle maintenance service data from the vehicle.

In at least one embodiment, the retrieving additional vehicle maintenance service data from the vehicle includes instructing the teleservice module of the vehicle to perform a remote key read, the additional vehicle maintenance service data being generated by the teleservice module performing the remote key read.

In at least one embodiment, the processor is further operable to, after receiving the confirmation message, generate a promotional message and transmitting the promotional message to the customer device, the promotional message offering additional services to be performed during the scheduled appointment.

In at least one embodiment, in response to receiving the vehicle maintenance service data and the customer data, the processor is operable to generate a repair order and store the repair order in storage.

In accordance with another broad aspect, a computer-based method of notifying a customer of a maintenance service to be performed on a vehicle is described herein. The method includes: receiving vehicle maintenance service data from the vehicle, the vehicle maintenance service data including vehicle identification data and an indication of a maintenance service due to be performed on the vehicle; based on the vehicle identification data, retrieving customer data of the customer associated the vehicle, the customer data including customer identification data; based on the customer identification data, generating a message notifying the customer of the maintenance service due to be performed on the vehicle and providing a hyperlink for the customer to use to schedule a service appointment for the vehicle; and transmitting the message to a customer device of the customer notifying the customer of the maintenance service to be performed on the vehicle.

In accordance with another broad aspect, a method of managing a database of vehicle inventory is described herein. The method includes: instructing a teleservice module of a vehicle to perform a remote key read; receiving vehicle maintenance service data from the vehicle, the vehicle maintenance service data generated by the teleservice module when performing the remote key read; processing the vehicle maintenance service data to determine if a parameter of the vehicle maintenance service data falls below a threshold value; if the parameter falls below the threshold value, generating a message indicating that the parameter falls below the threshold value; and transmitting the message to a third party device.

In accordance with another broad aspect, a method of managing a vehicle service visit is described herein. The method includes: scanning a license plate of the vehicle upon arrival of the vehicle at a service provider to obtain vehicle identification data of the vehicle; based on the vehicle identification data, retrieving customer identification data associated with the vehicle; based on the customer identification data and the vehicle identification data, instructing a teleservice module of the vehicle to perform a remote key read, the remote key read generating additional vehicle maintenance service data; generating a repair order based on the additional vehicle maintenance service data; and completing a vehicle maintenance service based on the repair order.

These and other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 is a block diagram 100 of components interacting with an example data management system, according to at least one embodiment described herein.

FIG. 2 is a flowchart of a method of providing automated vehicle service, according to at least one embodiment described herein.

FIG. 3 is a flowchart of a method of managing a database of vehicle inventory, according to at least one embodiment described herein.

FIG. 4 is a flowchart of a method of managing a vehicle service visit, according to at least one embodiment described herein.

FIG. 5. is a flowchart of a method of processing a lead for automated vehicle service, according to at least one embodiment described herein.

FIG. 6 is a flowchart of a method of managing a vehicle service visit, according to at least one embodiment described herein.

FIG. 7 is a flowchart of a method of managing a vehicle service visit, according to at least one embodiment described herein.

Further aspects and features of the example embodiments described herein will appear from the following description taken together with the accompanying drawings.

### DESCRIPTION OF EXAMPLE EMBODIMENTS

Various apparatuses, methods and compositions are described below to provide an example of at least one embodiment of the claimed subject matter. No embodiment described below limits any claimed subject matter and any claimed subject matter may cover apparatuses and methods that differ from those described below. The claimed subject matter are not limited to apparatuses, methods and compositions having all of the features of any one apparatus, method or composition described below or to features common to multiple or all of the apparatuses, methods or compositions described below. It is possible that an apparatus, method or composition described below is not an embodiment of any claimed subject matter. Any subject matter that is disclosed in an apparatus, method or composition described herein that is not claimed in this document may be the subject matter of another protective instrument, for example, a continuing patent application, and the applicant(s), inventor(s) and/or owner(s) do not intend to abandon, disclaim, or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures, and components have not been described in detail so as not to obscure the example embodiments described herein. Also, the description is not to be considered as limiting the scope of the example embodiments described herein.

It should be noted that terms of degree such as “substantially”, “about” and “approximately” as used herein mean a reasonable amount of deviation of the modified term such that the end result is not significantly changed. These terms of degree should be construed as including a deviation of the modified term, such as 1%, 2%, 5%, or 10%, for example, if this deviation does not negate the meaning of the term it modifies.

Furthermore, the recitation of any numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation up to a certain amount of the number to which reference is being made, such as 1%, 2%, 5%, or 10%, for example, if the end result is not significantly changed.

It should also be noted that, as used herein, the wording “and/or” is intended to represent an inclusive—or. That is, “X and/or Y” is intended to mean X, Y or X and Y, for example. As a further example, “X, Y, and/or Z” is intended to mean X or Y or Z or any combination thereof. Also, the expression of A, B and C means various combinations including A; B; C; A and B; A and C; B and C; or A, B and C.

The following description is not intended to limit or define any claimed or as yet unclaimed subject matter. Subject matter that may be claimed may reside in any combination or sub-combination of the elements or process steps disclosed in any part of this document including its claims and figures. Accordingly, it will be appreciated by a person skilled in the art that an apparatus, system or method disclosed in accordance with the teachings herein may embody any one or more of the features contained herein and that the features may be used in any particular combination or sub-combination that is physically feasible and realizable for its intended purpose.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers (referred to below as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information. The output information is applied to one or more output devices, in known fashion.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g., ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or download, magnetic and electronic storage media, digital and analog signals, and the like. The computer useable instructions may also be in various forms, including compiled and non-compiled code.

Recently, there has been a growing interest in developing new automated vehicle service systems, devices and methods.

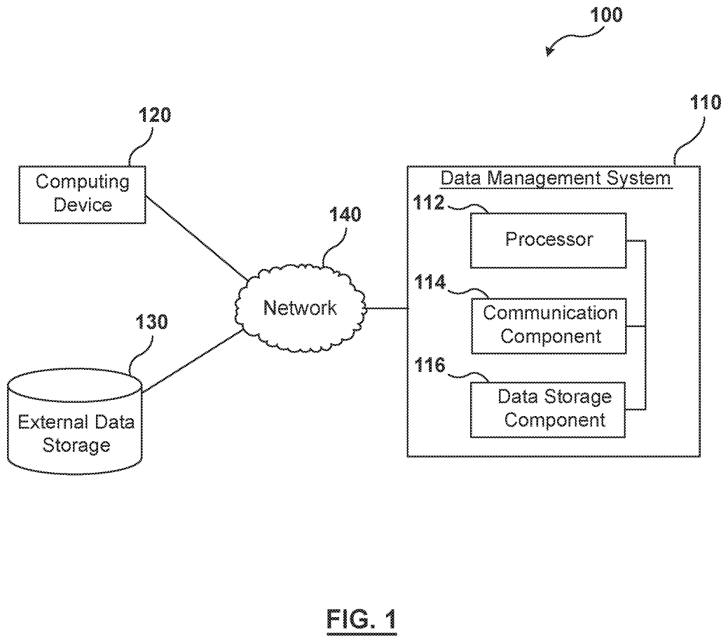

Reference is now made to FIG. 1, which illustrates a block diagram 100 of components interacting with an example data management system 110. As shown in FIG. 1, the data management system 110 is in communication with a computing device 120 and an external data storage 130 via a network 140.

The data management system 110 includes a management processor 112, a management communication component 114, and a management data storage component 116. The data management system 110 can be provided on one or more computer servers that may be distributed over a wide geographic area and connected via the network 140.

The data management system 110 can perform various functions related to electronic document management and data integration. For example, the data management system 110 can develop a user profile from information provided at the computing device 120. The data management system 110 can receive a data source, such as an electronic CAD file, from the computing device 120 and store the data source in external data storage 130. In the examples described herein, the data source typically includes information such as but not limited to related to one or more components of a vehicle. The data management system 110 can also access a data source stored in external data storage 130 and transmit the data source to the computing device 120.

The data management system 110 can also locate data sources accessible within network 140 and sequence the located data sources. For example, the data management system 110 can receive a connection or network information and the data management system 110 can locate data sources on a file server, database, or data warehouses. To locate data sources accessible within network 140, the data management system 110 can use various security and soft penetration techniques to identify what is accessible within the network. The data management system 110 can navigate directory structures, file properties, and database schemas to fingerprint databases, file servers, and data warehouses.

The data management system 110 can process data sources. For each data source, the data management system 110 can determine the data structure of the data source. In at least one embodiment, the data management system 110 can extract information from the data sources, or derive knowledge from the data sources, based on the data structure. The data management system 110 can build data structures based on knowledge derived from the data sources. In at least one embodiment, the data management system 110 can operate a graph engine to build such data structures based on knowledge derived from the data sources. The data management system 110 can receive and process requests for information from the data sources.

It will be appreciated that there can be a wide variety of data sources. Data sources can include, but is not limited to electronic files (i.e., electronic documents, portable document format (.pdf), images or pictures, text, computer-aided design (.cad)), data warehouses, websites, databases, file servers, hashes, application program interfaces (APIs). Furthermore, data sources need not be located within the same IT infrastructure as the data management system 110. That is, data sources may be located within third party networks.

The data management system 110 can determine that a data source has an unknown data structure. The data management system 110 can define new data structures. In at least one embodiment, the data management system 110 can receive user input to help define a new data structure. The data management system 110 can also make suggestions about the new data structure definition.

The management processor 112, the management communication component 114, and the management data storage component 116 can be combined into a fewer number of components or can be separated into further components. The management processor 112, the management communication component 114, and the management data storage component 116 may be implemented in software or hardware, or a combination of software and hardware.

The management processor 112 can operate to control the operation of the data management system 110. The management processor 112 can initiate and manage the operations of each of the other components within the data management system 110. The management processor 112 may be any suitable processors, controllers, digital signal processors, or graphics processing units (GPUs) that can provide sufficient processing power depending on the configuration, purposes and requirements of the data management system 110. In some embodiments, the management processor 112 can include more than one processor with each processor being configured to perform different dedicated tasks.

The management communication component 114 may include any interface that enables the data management system 110 to communicate with other devices and systems. In some embodiments, the management communication component 114 can include at least one of a serial port, a parallel port or a USB port. The management communication component 114 may also include at least one of an Internet, Local Area Network (LAN), Ethernet, Firewire, modem or digital subscriber line connection. Various combinations of these elements may be incorporated within the management communication component 114.

For example, the management communication component 114 may receive input from various input devices, such as a mouse, a keyboard, a touch screen, a thumbwheel, a track-pad, a track-ball, a card-reader, voice recognition software and the like depending on the requirements and implementation of the data management system 110.

The management data storage component 116 can include RAM, ROM, one or more hard drives, one or more flash drives or some other suitable data storage elements such as disk drives, etc. Similar to the management data storage component 116, the external data storage 130 can also include RAM, ROM, one or more hard drives, one or more flash drives or some other suitable data storage elements such as disk drives, etc.

The management data storage component 116 and the external data storage 130 can also include one or more databases for storing data sources, user profiles, and data structures. In at least one embodiment, the management data storage component and the external data storage 130 can store a unified split data structure.

The computing device 120 can include any networked device operable to connect to the network 140. A networked device is a device capable of communicating with other devices through a network such as the network 140. A networked device may couple to the network 140 through a wired or wireless connection. Although only one computing device 120 is shown in FIG. 1, it will be understood that more computing devices 120 can connect to the network 140.

The computing device 120 may include at least a processor and memory, and may be an electronic tablet device, a personal computer, workstation, server, portable computer, mobile device, personal digital assistant, laptop, smart phone, WAP phone, an interactive television, video display terminals, gaming consoles, and portable electronic devices or any combination of these.

The computing device 120 can be associated with a user profile. The user can provide authentication credentials to access the network 140 and transmit data to the data management system 110.

The network 140 may be any network capable of carrying data, including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX, Ultra-wideband, Bluetooth®), SS7 signaling network, fixed line, local area network, wide area network, and others, including any combination of these, capable of interfacing with, and enabling communication between, the data management system 110, the computing device 120 and the external data storage 130.

It will be understood that some components of FIG. 1, such as components of the data management system 110 or the external data storage 130, can be implemented in a cloud computing environment.

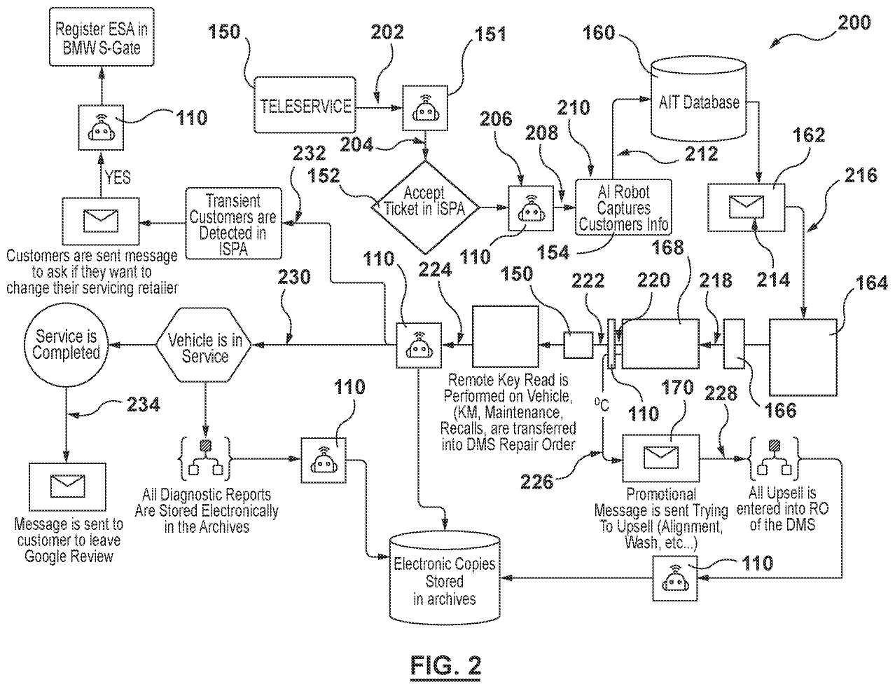

Reference is now made to FIG. 2, which illustrates a flowchart of a method 200 of providing automated vehicle service, in accordance with an example embodiment. A data management system, such as data management system 110 having a processor 112 can be configured to implement at least a portion of the method 200.

Method 200 begins at step 202 with a teleservice module 150 of a vehicle, for example, uploading a data source, such as an electronic file, to a vehicle manufacturer specific data management system (DMS) 151. The electronic file can be transmitted from the vehicle to vehicle manufacturer specific DMS 151 via a network, such as network 140. In at least one embodiment, the electronic file can be automatically transmitted from the vehicle to vehicle manufacturer specific DMS 151 when the vehicle determines that a maintenance service should be performed on the vehicle.

In at least one embodiment, the electronic file can be an electronic document containing text data. Text data can include structured string text or unstructured text. In at least one embodiment, the electronic file may include vehicle-related service data indicating a need for a maintenance service of the vehicle. In at least one embodiment, the electronic file may include Condition Based Service (CBS) data. CBS data may include CBS maintenance service data including, but not limited to including, an indication that one or more maintenance services are due to be performed on the vehicle. CBS data may also include a mileage of the vehicle, a battery condition of a battery of the vehicle, a fuel level of the vehicle and/or any outstanding recalls or service campaigns that are due to be performed on the vehicle.

Upon receipt of the electronic file at the vehicle manufacturer specific DMS 151, at step 204, to vehicle manufacturer specific DMS 151 transmits the electronic file to a vehicle manufacturer specific dealer-level diagnostic software program 152. For example, without limiting the foregoing, the vehicle manufacturer specific dealer-level diagnostic software program 152 may be IPSA Next by BMW®.

At step 206, data management system 110 extracts the CBS data from the information from the vehicle manufacturer specific dealer-level diagnostic software program 152 and stores the CBS data in a local database 160. Data management system 110 may extract the CBS data using any extraction technique known in the art.

At step 206, data management system 110 also translates the CBS data to Reynolds® operation codes by robotic process automation. Herein, the term “robotic process automation”, or RPA, refers to a form of business process automation technology based on metaphorical software robots or on artificial intelligence (AI)/digital workers. Specifically, RPA systems develop an action list for performing a task by watching the user perform that task in a graphical user interface (GUI) of an application, and then perform the automation by repeating those tasks directly in the GUI.

At step 208, data management system 110 can generate a second electronic file based on the electronic file received from the vehicle. The second electronic file may be formatted to be processed by a vehicle dealer-level customer relation management (CRM) software program 154. For example, without limiting the foregoing, the data management system 110 may generate and transmit the second electronic file in a format suitable to be processed by a vehicle dealer-level CRM software program 154 by Reynolds®. The second electronic file may instruct the vehicle dealer-level CRM software program 154 to transmit customer information associated with the vehicle to the data management system 110.

Upon the vehicle dealer-level CRM software program 154 receiving the second electronic file, at step 208, the vehicle dealer-level CRM software program 154 processes the second electronic file. For example, the vehicle dealer-level CRM software program 154 may determine a customer of the dealership associated with the vehicle to be serviced.

At step 210, the data management system 110 extracts data including customer data from the vehicle dealer-level CRM software program 154. For example, in at least one embodiment, customer data is extracted in batch by the data management system 110 from the from the vehicle dealer-level CRM software program 154 and input into the local database 160. In at least one embodiment, data management system 110 extracts data including customer data from the vehicle dealer-level CRM software program 154 based on the CBS data. In at least one embodiment, data management system 110 extracts data including additional customer data from a vehicle manufacturer specific customer data software program, such as but not limited to BMW® Connected Drive, stored on the vehicle or on a third party server and/or through a web-based portal. In at least one embodiment, data management system 110 extracts data including additional customer data from vehicle manufacturer specific dealer-level diagnostic software program 152, such as but not limited to IPSA Next by BMW®. In at least one embodiment, data management system 110 extracts data including additional customer data using robotic process automation.

For example, the data management system 110 can capture or extract customer data that includes but is not limited to “ID” data (such as but not limited to “First_Name” data and “Last_Name” data), “Address ID” data, “Vin” data, “Make” data, “Model” data, and “Manufacturer” data, “EmailID” data, “Phone Number” data and the like.

At step 212, the data management system 110 can transmit the customer data from the vehicle dealership specific software program 154 to a database 160 for storage, such as but not limited to an Automotive Intelligence Technologies (AIT) database 160.

At step 214, based on the customer data, the data management system 110 can generate a first message 162 for transmitting to a customer device 164 associated with the customer data. The first message 162 includes an indication of a maintenance service recommended by teleservice module 150 of the vehicle to be performed on the vehicle. The first message 162 also includes a hyperlink to a website having a schedule for the customer to make an appointment for the dealership to provide the service. The website hosting the schedule may be managed by the vehicle dealership specific software program 154.

At step 216, the data management system 110 transmits the first message 162 to the customer device 164 over network 140.

In at least one embodiment, data management system 110 extracts appointment scheduling information from vehicle dealer-level CRM software program 154 and uses logic to determine maintenance services to be performed during a scheduled appointment.

Once the customer has scheduled a maintenance appointment with the dealership for the maintenance service to be performed, at step 218, at a time prior to the maintenance appointment (e.g., 24 hours before), data management system 110 generates and transmits a second message 166 to the customer device 164.

The second message 166 includes text providing the customer with a reminder of the scheduled appointment. The second message 166 also includes text requesting that the customer acknowledge receipt by, for example, responding to the second message 166 by entering a user input into customer device 164 and transmitting a response message 168.

At step 220, the customer device 164 generates and transmits the response message 168 to the data management system 110. The response message 168 may include a single text character as the user input that confirms that the customer has read the second message 166 and manually input the single text character as user input for transmitting with the response message 168. For example, the single text character may be a letter “C” to confirm that the customer has acknowledged receipt of the second reminder message 166.

Once the data management system 110 has received the response message 168 from the customer device 164, a series of steps can occur, either simultaneously or sequentially.

At step 222, the data management system 110 can generate and transmit a message to the teleservice module 150 directing the teleservice module 150 to perform a Remote Key Read on the vehicle. The Remote Key Read triggers the teleservice module 150 to generate a list of maintenance services that are recommended to be performed on the vehicle.

In response, at step 224, the teleservice module 150 can transmit a data source to the data management system 110 providing vehicle-related service data to the data management system 110, the vehicle-related service data being based on the Remote Key Read performed by the teleservice module 150. In at least one embodiment, the vehicle-related service data received by the data management system 110 from the teleservice module 150 at step 224 may be the same as the service data received by the data management system 110 from the teleservice module 150 at step 202. In at least one embodiment, the vehicle-related service data received by the data management system 110 from the teleservice module 150 at step 222 may be different than the service data received by the data management system 110 from the teleservice module 150 at step 202. For example, the teleservice module 150 may provide vehicle-related service data recommending additional maintenance services be performed on the vehicle that were not originally provided the data management system 110 by the teleservice module 150 at step 202. The additional maintenance services may include, but are not limited to a maintenance recall.

At a step 226, the data management system 110 can generate a promotional message 170 that is transmitted to customer device 164. Promotional message 170 may include text offering additional product and/or services to the customer to be performed during their scheduled service appointment. As noted above with respect to second message 166, promotional message 170 may request user input via customer device 164 to confirm the customer's desire to schedule the performance of additional services and/or to confirm the purchase of additional products, such as but not limited to a car wash, an alignment service, or the like.

As step 228, a confirmation message 172 may be received at the data management system 110 from the customer device 164 confirming the customer's desire to have additional services performed and/or additional products purchased. In at least one embodiment, data management system 110 may automatically extract specific services and/or products from confirmation message 172 and enter the additional services performed and/or additional products purchased into the Repair Order stored by the data management system 110.

Upon receipt of the vehicle-related service data by the data management system 110, at step 224, a series of steps can occur, either performed simultaneously or sequentially by the data management system 110.

First, at step 230, the customer may have the maintenance service completed by technicians at the dealership. During the appointment and the performance of the maintenance service, one or more diagnostic reports may be generated by the vehicle. In these case, the one or more diagnostic reports may be stored by the data management system 110.

In at least one embodiment, at an optional step 232, transient customers may be detected by the ISPA and the data management system 110 may send a confirmation message 174 to the customer device 164 asking the customer if they would like to change their servicing retailer. If the customer confirms that they would like to change their servicing retailer, data management system 110 may automatically generate a list of other servicing retailers as a recommendation and transmit the list of other servicing retailers to the customer device 164.

In at least one embodiment, following completion of the maintenance services, data management system 110 may automatically generate and transmit a request, at step 234, for the customer to complete a review of their appointment experience.

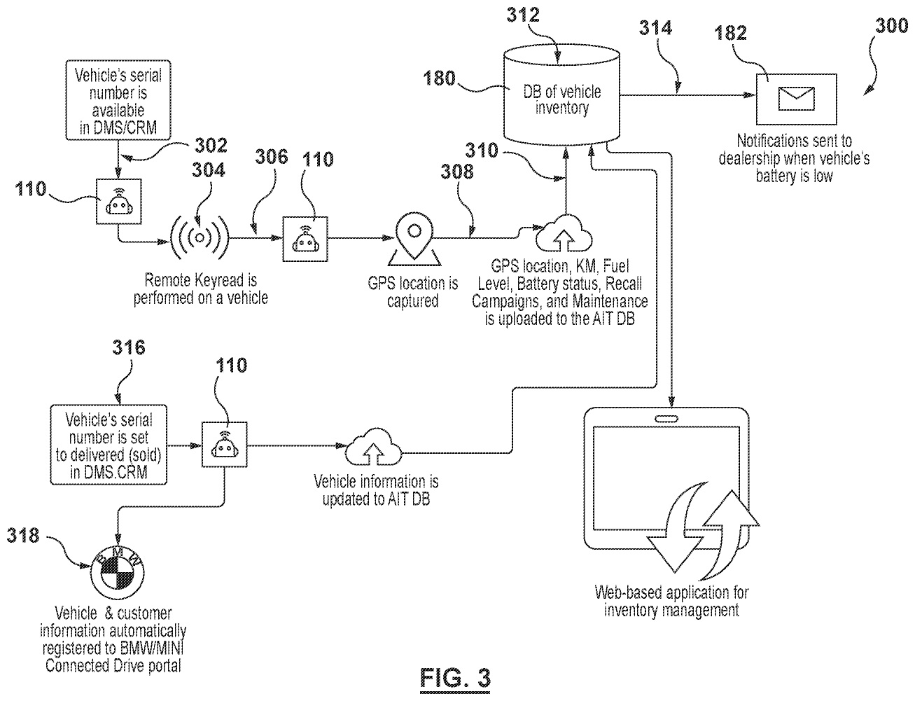

Reference is now made to FIG. 3, which illustrates a flowchart of a method 300 of managing a database of vehicle inventory, in accordance with another example embodiment.

In at least one embodiment described herein, method 300 provides for managing a database of vehicle inventory, such as but not limited to vehicle inventory at a car dealership.

At a step 302 of the method 300, data management system 100 receives a vehicle serial number for at least one vehicle.

Using the vehicle serial number, at step 304, the data management system 100 directs instructs a remote key read to be performed on the vehicle. The remote key read triggers the vehicle to pull information from is service sensors regarding the condition of the vehicle (the vehicle service information) and push this vehicle service information, as step 306, to the data management system 110. The vehicle service information may include information such as but not limited to odometer reading, fuel level, battery status, recall campaigns, and maintenance reminders or notifications, for example.

At a step 308 of the method 300, data management system 100 receives a Global Positioning System (GPS) location of the vehicle from the vehicle.

At step 310, the vehicle service information together with the GPS location are stored in a database 180 of vehicle inventory information by the data management system 110.

At step 312, data management system 110 may process the vehicle service information stored in the database 180 and, at step 314, may generate and transmit one or more messages 182 to the dealership. For example, data management system 110 may receive the vehicle service information from one or more vehicles and determine that the batter status of one of the vehicles is below a threshold level for battery status. In response, the data management system 110 may generate and transmit message 182 to the dealership indicating that the battery status of one of the vehicles is below the threshold value.

At step 314, a notification 182 may be sent to a vehicle dealership when a vehicle's batter is low.

At step 316, a vehicle is marked as delivered in the data management system 110 (or, optionally, in vehicle dealer-level CRM software program 154). This data may be extracted at set time intervals (e.g., monthly) and, through robotic process automation, an Electronic Subscriber Agreement (ESA) is completed. An ESA is the customers consent to use features of the system, such as but not limited to, BMW® Teleservice and other Connected Drive features.

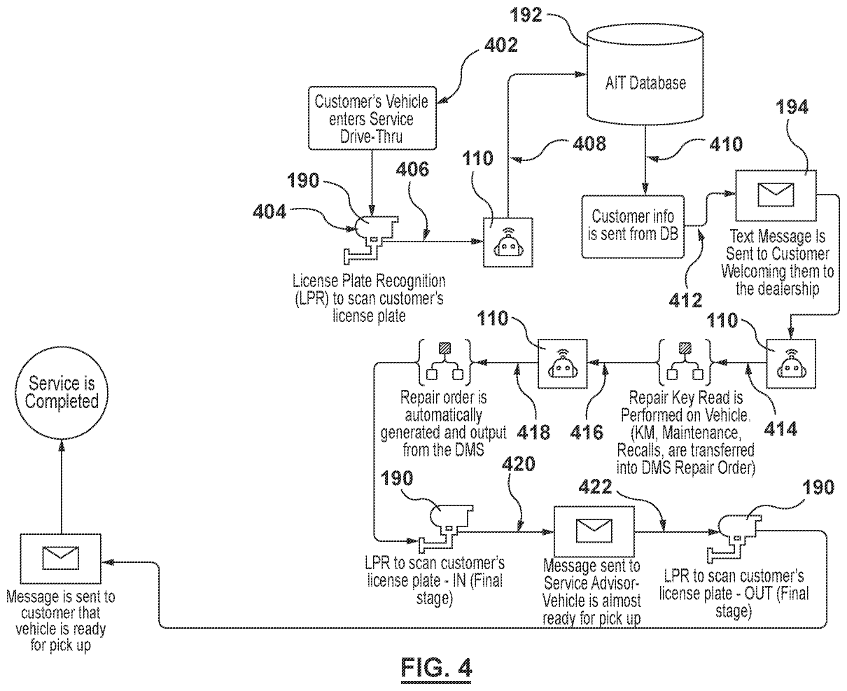

Reference is now made to FIG. 4, which illustrates a flowchart of a method 400 of managing a service visit of a vehicle, in accordance with another example embodiment.

At step 402, a customer's vehicle enters a facility of the service provider. In at least one embodiment, upon entering the facility, a scanner 190 of the service provider may, at a step 404, conduct a scan of a license plate of the vehicle to identify the vehicle as it enters the facility.

At step 406, the scanner 190 may provide the scanned information to the data management system 110, which processes the information at step 408 and transmits a request to a database 192 to retrieve customer information related to the vehicle.

At step 410, database 192 collects customer information and transmits the customer information to the data management system 110, which generates a message 194 and transmits the message at step 412 to a customer device associated with the customer. Message 194 may include text information welcoming the customer to the dealership and/or providing the customer with information about the dealership and/or the services to be performed that day.

At step 414, data management system 110 directs the vehicle to perform a Remote Key Read and re-transmit, at step 416, the vehicle service information generated as a result to the data management system 110

At step 418, the data management system 110 generates a Repair Order based on the vehicle service information generated by the Remote Key Read.

At step 424, a message 198 is generated by the data management system 110 and transmitted to the customer device indicating that the services being performed are complete and, optionally, that the vehicle is ready to be picked up.

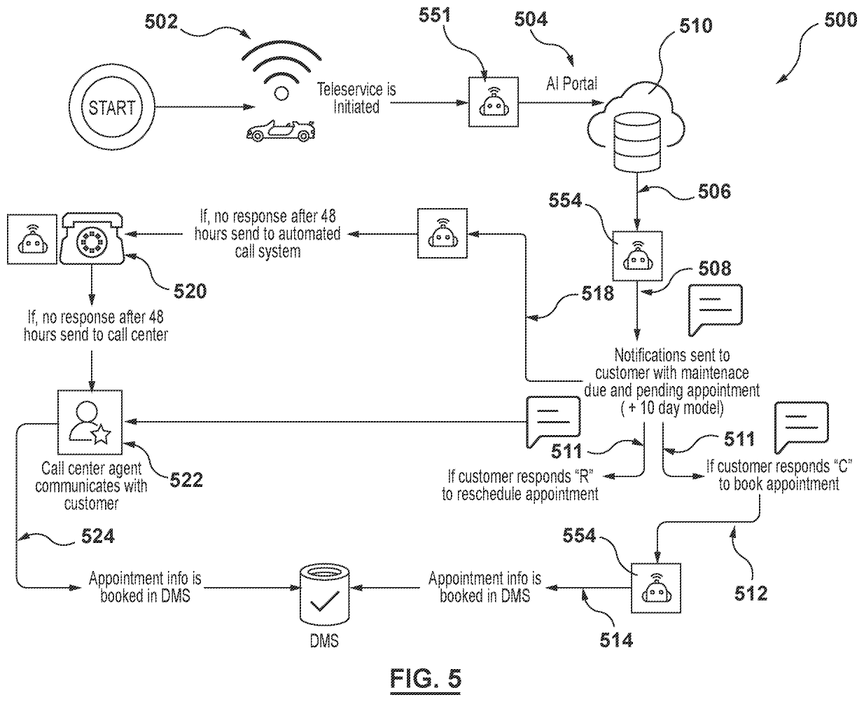

Turning to FIG. 5, shown therein is a flowchart of another method 500 of processing a lead for automated vehicle service, in accordance with an example embodiment. Therein, as noted in the methods described above, a data management system, such as data management system 110, having a processor 112, can be configured to implement at least a portion of the method 500.

Method 500 begins at step 502 with a teleservice module 550 of a vehicle, for example, uploading a data source, such as an electronic file, to a vehicle manufacturer specific DMS 551. The electronic file can be transmitted from the vehicle to vehicle manufacturer specific DMS 551 via a network, such as network 140 described above. In at least one embodiment, the electronic file can be automatically transmitted from the vehicle to vehicle manufacturer specific DMS 551 when the vehicle determines that a maintenance service should be performed on the vehicle. Upon receipt of the electronic file at the vehicle manufacturer specific DMS 551, vehicle manufacturer specific DMS 551 may optionally transmit the electronic file to a vehicle manufacturer specific dealer-level diagnostic software program 552.

In an alternate embodiment, step 502 may proceed with a DMS or OEM database may store data that uses time and/or mileage logic to predict when service should be performed on the vehicle a vehicle, for example. The DMS or OEM database may generate an electronic file based on the prediction at the vehicle manufacturer specific DMS 551 and, as noted above, vehicle manufacturer specific DMS 551 may optionally transmit the electronic file to a vehicle manufacturer specific dealer-level diagnostic software program 552.

Returning to FIG. 5, at step 504, data management system 510 receives CBS data and/or information from the vehicle manufacturer specific dealer-level diagnostic software program 552 and stores the CBS data in a local database. Data management system 510 may extract the CBS data using any extraction technique known in the art. Data management system 510 also translates the CBS data to Reynolds® operation codes by robotic process automation.

At step 506, data management system 510 generates a second electronic file based on the electronic file received from DMS 551. The second electronic file may be formatted to be processed by a vehicle dealer-level customer relation management (CRM) software program 554. For example, without limiting the foregoing, the data management system 510 may generate and transmit the second electronic file in a format suitable to be processed by a vehicle dealer-level CRM software program 554 by Reynolds®. The second electronic file may instruct the vehicle dealer-level CRM software program 554 to transmit service information (e.g., service and/or maintenance that is due to be performed on the vehicle) and/or appointment information to the associated customer, such as but not limited as an electronic mail item and/or an SMS message (or the like). At step 508, the vehicle dealer-level CRM software program 554 transmits the service information and/or appointment information to the customer.

In at least one embodiment, upon receipt of the service information and/or appointment information, the customer may respond by sending a message back to the vehicle dealer-level customer relation management (CRM) software program 554. For example, at step 511, the customer may confirm its desire to have proposed services and/or maintenance of the service information and/or confirm a proposed date and time in the appointment information and transmit a message back to the vehicle dealer-level CRM software program 554 at step 514. Upon receipt, vehicle dealer-level CRM software program 554, the vehicle dealer-level CRM software program 554 may transmit the appointment information and/or service information, at step 514, to the vehicle manufacturer specific DMS 551 for storage.

In at least one embodiment, the customer may, at step 516, send a message back to the vehicle dealer-level CRM software program 554 requesting another appointment date and time and/or deny performance of the proposed service(s).

If the customer does not respond to the vehicle dealer-level CRM software program 554 message including the service information and/or appointment information, a step 518 within a predefined time period (e.g., 48 hours), an automated call system may call the customer to provide the customer with the service information and/or appointment information at step 520. If the customer does not answer the call and/or return the call within a second predefined period, a call centre agent may reach out to the customer directly at step 522. Any subsequent appointment information can be stored in the DMS 510 at step 524.

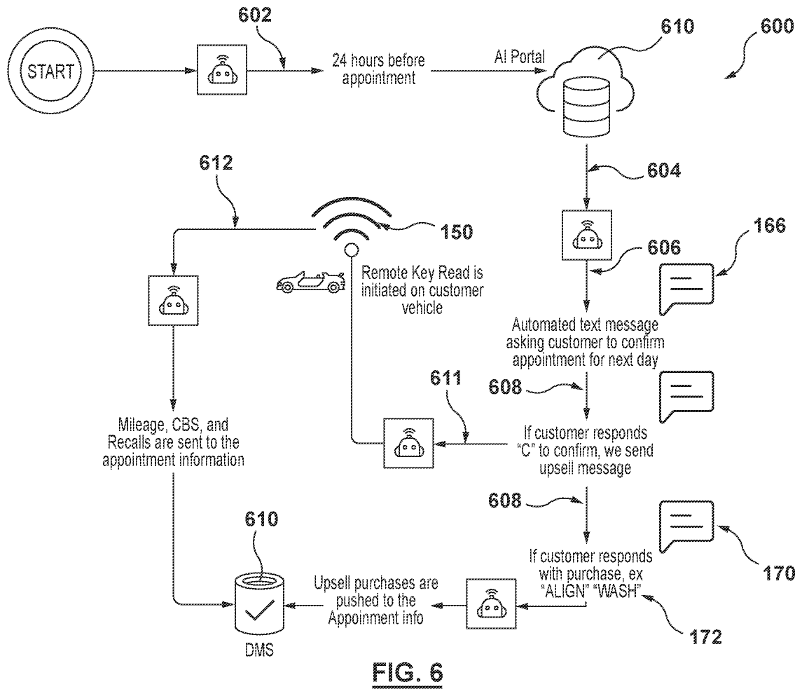

Turing to FIG. 6, shown therein is a flow chart of a method of managing a vehicle service visit 600. Once the customer has scheduled a maintenance appointment with the dealership for the maintenance service to be performed, at step 602, at a time prior to the maintenance appointment (e.g., 24 hours before, or 48 hours before, or 72 hours before, or one week before, or more than one week before), the vehicle dealer-level CRM software program 554 may poll the data management system 510 to receive a reminder of appointments for service and/or maintenance that are approaching. In response, at step 604, data management system 610 may generate and transmits a second message to the vehicle dealer-level CRM software program 554 instructing the vehicle dealer-level CRM software program 554 to transmit a reminder message to the customer at step 606.

The reminder message may include text providing the customer with a reminder of the scheduled appointment. The reminder message may also include text requesting that the customer acknowledge receipt by, for example, responding to the reminder message by entering a user input into, for example, their customer device and transmitting a response message.

At step 608, the customer via the customer device generates and transmits the response message to the vehicle dealer-level CRM software program 554. The response message may include a single text character as the user input that confirms that the customer has read the reminder message and manually input the single text character as user input for transmitting with the response message. For example, the single text character may be a letter “C” to confirm that the customer has acknowledged receipt of the reminder message.

Once the vehicle dealer-level CRM software program 554 has received the response message from the customer device, a series of steps can occur, either simultaneously or sequentially.

For example, the data management system 610 can generate and transmit a message to the teleservice module 150 at step 611 directing the teleservice module 150 to perform a Remote Key Read on the vehicle. The Remote Key Read triggers the teleservice module 150 to generate a list of maintenance services that are recommended to be performed on the vehicle. This can act as a check to see if there are additional maintenance services that are recommended to be performed on the vehicle that have arisen since the appointment was originally scheduled.

In response, at step 612, the teleservice module 150 can transmit a data source to the data management system 610 providing vehicle-related service data to the data management system 610, the vehicle-related service data being based on the Remote Key Read performed by the teleservice module 150. In at least one embodiment, the vehicle-related service data received by the data management system 610 from the teleservice module 150 at step 612 may be the same as the service data received previously. In at least one embodiment, the vehicle-related service data received by the data management system 610 from the teleservice module 150 at step 612 may be different than the service data received previously. For example, the teleservice module 150 may provide vehicle-related service data recommending additional maintenance services be performed on the vehicle that were not originally provided the data management system 610 by the teleservice module 150. The additional maintenance services may include, but are not limited to a maintenance recall. This information may be stored, for example, in a DMS 610.

At a step 614, the data management system 610 can generate a promotional message 170 that is transmitted to customer device 164. Promotional message 170 may include text offering additional product and/or services to the customer to be performed during their scheduled service appointment. As noted above with respect to second message 166, promotional message 170 may request user input via customer device 164 to confirm the customer's desire to schedule the performance of additional services and/or to confirm the purchase of additional products, such as but not limited to a car wash, an alignment service, or the like.

As step 228, a confirmation message 172 may be received at the data management system 610 from the customer device 164 confirming the customer's desire to have additional services performed and/or additional products purchased. In at least one embodiment, data management system 610 may automatically extract specific services and/or products from confirmation message 172 and enter the additional services performed and/or additional products purchased into the Repair Order stored by the data management system 610.

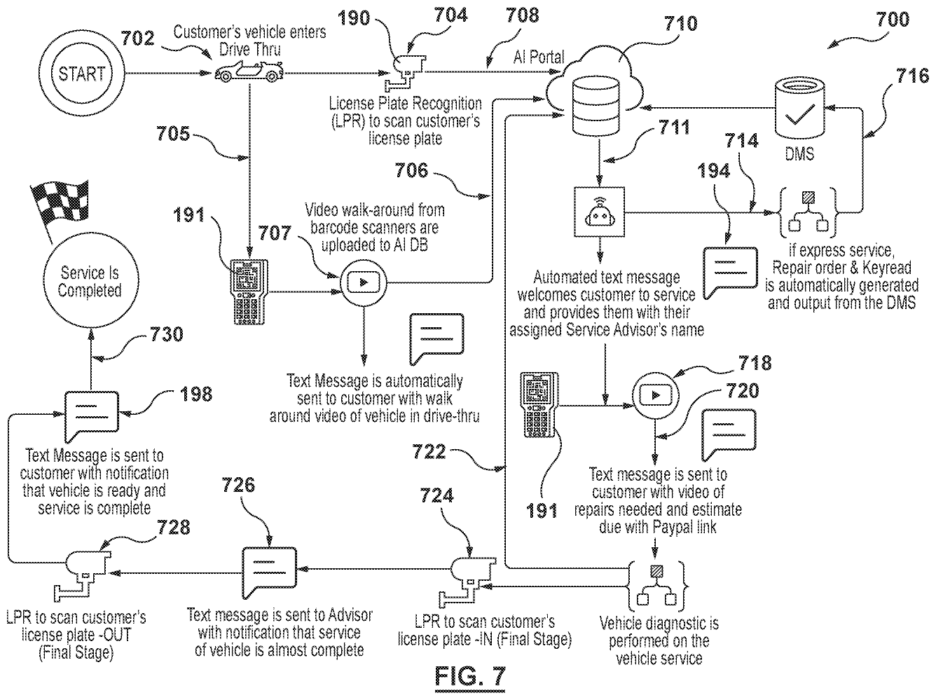

Turning to FIG. 7 is a flowchart of a method 700 of managing a vehicle service visit, according to at least one embodiment described herein.

At step 702, a customer's vehicle enters a facility of the service provider. In at least one embodiment, upon entering the facility, a scanner 190 of the service provider may, at a step 704, conduct a scan of a license plate of the vehicle to identify the vehicle as it enters the facility.

Optionally, in parallel with the license plate scan, at a step 705, a user may use a portable recording device 191 to record a video of external features of the car. This may hereinafter be referred to as a walk-around video of the vehicle.

At step 707, the walk-around video of the vehicle may optionally be transmitted (e.g., wirelessly) from the portable recording device 191 to a device of the customer (e.g., via an SMS message).

At step 706, the scanner 190 and/or the portable recording device 191 may provide the scanned information and/or the walk-around video, respectively, to the data management system 710, which processes the information at step 709 and transmits a request to a processor that can access a database (not shown) to retrieve customer information related to the vehicle. A processor collects the customer information and transmits the customer information back to the data management system 710.

At step 711, data management system 710 generates a message 194 and transmits the message to a customer device associated with the customer. Message 194 may include text information welcoming the customer to the dealership and/or providing the customer with information about the dealership and/or the services to be performed that day and/or a name of a service advisor.

After an assessment of the vehicle, which may optionally include the user may using portable recording device 191 to record a video, at step 718, including images of features of the car that require service and/or maintenance, portable recording device 191 may transmit a message to the customer device, at step 720, including the video including images of features of the car that require service and/or maintenance, or a link to the video if the video is stored on an external server. The message may optionally cost information for performing the services and/or maintenance and a link to a third party payment site for processing a payment from the customer to the dealership housing the system 700.

At step 722, data management system 110 may perform a diagnostic (e.g., triggers a processor on the vehicle to return any service or maintenance codes from one or more systems of the vehicle that may require service and/or maintenance) on the vehicle to confirm if any other services or maintenance should be performed on the vehicle. If the diagnostic returns services and/or maintenance that is recommended to be performed (e.g., by the manufacturer of the vehicle), this information can be forwarded to the data management system 110 at step 718. direct the vehicle to perform a Remote Key Read and re-transmit, at step 716, the vehicle service information generated as a result to the data management system 110. In some embodiments, a diagnostic may not be performed.

At step 724, a second license plate scan of the vehicle may be performed to indicate to the DMS 110 that service has begun to be performed on the vehicle.

At step 726, a message 198 is generated by the data management system 110 and transmitted to the advisor indicating that the services being performed are complete or, optionally, almost complete.

At step 728, a third license plate scan of the vehicle may be performed to indicate to the DMS 110 that service is complete.

At step 730, a message 198 is generated by the data management system 110 and transmitted to the customer device indicating that the services being performed are complete and, optionally, that the vehicle is ready to be picked up.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. A system for notifying a customer of a maintenance service to be performed on a vehicle, the system comprising:
a communication component to communicate with the vehicle via a network; and
at least one processor in communication with the communication component, the at least one processor being operable to:
receive vehicle maintenance service data from the vehicle, the vehicle maintenance service data including vehicle identification data and an indication of a maintenance service due to be performed on the vehicle;
based on the vehicle identification data, retrieve customer data of the customer associated the vehicle, the customer data including customer identification data;
based on the customer identification data, generate a message notifying the customer of the maintenance service due to be performed on the vehicle and providing a hyperlink for the customer to use to schedule a service appointment for the vehicle; and
transmit the message to a customer device of the customer notifying the customer of the maintenance service to be performed on the vehicle.

2. The system of claim 1, wherein the vehicle maintenance service data is received by the communication component from a teleservice module of the vehicle.

3. The system of claim 1, wherein the customer data is stored in a vehicle dealer-level software program.

4. The system of claim 1 further comprising, after the customer schedules the service appointment, generating a second message reminding the customer of the service appointment.

5. The system of claim 4 further comprising, after generating the second message reminding the customer of the service appointment, receiving a confirmation message from the customer device, the confirmation message including an acknowledgement from the customer device of the service appointment.

6. The system of claim 5 further comprising, after receiving the confirmation message, retrieving additional vehicle maintenance service data from the vehicle.

7. The system of claim 6, wherein the retrieving additional vehicle maintenance service data from the vehicle includes instructing the teleservice module of the vehicle to perform a remote key read, the additional vehicle maintenance service data being generated by the teleservice module performing the remote key read.

8. The system of claim 5 further comprising, after receiving the confirmation message, generating a promotional message and transmitting the promotional message to the customer device, the promotional message offering additional services to be performed during the scheduled appointment.

9. The system of claim 1, wherein, in response to receiving the vehicle maintenance service data and the customer data, the processor is configured to generate a repair order and store the repair order in storage.

10. A computer-based method of notifying a customer of a maintenance service to be performed on a vehicle, the method comprising:
receive vehicle maintenance service data from the vehicle, the vehicle maintenance service data including vehicle identification data and an indication of a maintenance service due to be performed on the vehicle;
based on the vehicle identification data, retrieve customer data of the customer associated the vehicle, the customer data including customer identification data;
based on the customer identification data, generate a message notifying the customer of the maintenance service due to be performed on the vehicle and providing a hyperlink for the customer to use to schedule a service appointment for the vehicle; and
transmit the message to a customer device of the customer notifying the customer of the maintenance service to be performed on the vehicle.

11. The method of claim 10, wherein the vehicle maintenance service data is received by the communication component from a teleservice module of the vehicle.

12. The method of claim 10, wherein the customer data is stored in a vehicle dealer-level software program.

13. The method of claim 10 further comprising, after the customer schedules the service appointment, generating a second message reminding the customer of the service appointment.

14. The method of claim 13 further comprising, after generating the second message reminding the customer of the service appointment, receiving a confirmation message from the customer device, the confirmation message including an acknowledgement from the customer device of the service appointment.

15. The method of claim 14 further comprising, after receiving the confirmation message, retrieving additional vehicle maintenance service data from the vehicle.

16. The method of claim 15, wherein the retrieving additional vehicle maintenance service data from the vehicle includes instructing the teleservice module of the vehicle to perform a remote key read, the additional vehicle maintenance service data being generated by the teleservice module performing the remote key read.

17. The method of claim 14 further comprising, after receiving the confirmation message, generating a promotional message and transmitting the promotional message to the customer device, the promotional message offering additional services to be performed during the scheduled appointment.

18. (canceled)

19. A method of managing a vehicle service visit, the method comprising:
scanning a license plate of the vehicle upon arrival of the vehicle at a service provider to obtain vehicle identification data of the vehicle;
based on the vehicle identification data, retrieving customer identification data associated with the vehicle;
based on the customer identification data and the vehicle identification data, instructing a teleservice module of the vehicle to perform a remote key read, the remote key read generating additional vehicle maintenance service data;
generating a repair order based on the additional vehicle maintenance service data; and
completing a vehicle maintenance service based on the repair order.
